(19) United States
(12) Patent Application Publication
(10) Pub. No.: US 2010/0277509 A1
(43) Pub. Date: Nov. 4, 2010

(54) METHOD OF UPDATING THE DISPLAY OF ELECTROPHORETIC DISPLAY MECHANISM AND THE DEVICE THEREOF

(76) Inventors: Qi-Ming Lu, Changhua County (TW); Hung-Hsiang Chen, Taoyuan County (TW); Jhen-Shen Liao, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/490,329

(22) Filed: Jun. 24, 2009

(30) Foreign Application Priority Data
Apr. 29, 2009 (TW) 098114209

(51) Int. Cl. G09G 5/10; G09G 3/34

(52) U.S. Cl. 345/690; 345/107

(57) ABSTRACT

A method for driving an electrophoretic display device for reducing the time required to update the display image. The electrophoretic display device comprises a frame buffer, a lookup table, a controller and an electrophoretic display panel. The frame buffer stores a first display frame data. The controller accesses a transition data of transforming the first display frame data to a second display frame data according to the lookup table, for outputting a control data. The electrophoretic display panel displays the second display frame data according to the control data. Therefore, the position the charged particle in a pixel to be moved to during the erasing step can be adjusted by utilizing the lookup table, consequently reducing the time required to update the pixel.

### BACKGROUND OF THE INVENTION

1. Field of the Invention

The present invention relates to a method for driving an Electrophoretic Display (EPD), and more particularly, to a method for driving an EPD by adjusting the position of the electrophoretic particles to be moved to during the erasing step for improving the display refresh time.

2. Description of the Prior Art

Please refer to FIG. 1. FIG. 1 is a diagram illustrating a conventional EPD device 100. The conventional EPD device 100 comprises a plurality of charged particles 101, an electrophoretic medium 102, an upper electrode 103, and a lower electrode 104. The upper electrode 103 and the lower electrode 104 are respectively located at the two sides of the electrophoretic medium 102. The upper electrode 103 is a transparent electrode and the lower electrode 104 is a segmented metal electrode. The charged particles 101, which carry positive charges, are suspended in the electrophoretic medium 102. The charged particles 101 are of a different color compare to the electrophoretic medium 102. The charged particles 101 are typically white Titanium Dioxide (TiO₂) particles, which means the color of the charged particles 101 are white, and the color of the electrophoretic medium 102 is black. The position of the charged particles 110 in the electrophoretic medium 102 is adjusted by applying an external driving voltage to the upper electrode 103 and the lower electrode 104 for creating an electric field, so as to display the color contrast between the charged particles 101 and the electrophoretic medium 102, for representing different grey levels of the displayed frame.

The different positions of the charged particles 101 in the electrophoretic medium 102 allow the EPD device 100 to display corresponding grey levels. As shown in FIG. 1, the charged particles 101 of the pixel P1 are in a position that is close to the upper electrode 103 of the electrophoretic medium 102, for the pixel P1 to display a white color. The charged particles 101 of the pixel P2 are in a position that is close to the lower electrode 104 in the electrophoretic medium 102, for the pixel P2 to display a black color. The charged particles 101 of the pixel P3 are in a middling position in the electrophoretic medium 102, for the pixel P3 to display a grey-level color. Therefore, the position of the charged particles 101 in the electrophoretic medium determines the grey level of the corresponding pixel. In other words, the EPD device operates in a reflective display mechanism and does not require a backlight source. The position of the charged particles 101 in the electrophoretic medium 102 is determined by the polarity and the pulse period of the driving voltage applied to the upper electrode 103 and the lower electrode 104. The polarity of the driving voltage determines the movement direction (i.e. the brightening or darkening of the grey level) of the charged particle 101 in the electrophoretic medium 102. For example, applying a positive driving voltage moves the charged particle 101 towards the upper electrode 103 so the grey level displayed transforms toward white; applying a negative driving voltage moves the charged particle 101 towards the lower electrode 104, so the grey level displayed transforms towards black. The pulse period of the driving voltage determines the distance of the movement (i.e. the degree of the grey level is varied) of the charged particle 101 in the electrophoretic medium 102.

Please refer to FIG. 1 and FIG. 2 together. FIG. 2 is a diagram illustrating the movement of the charged particles 101 when the driving voltage is applied. When the EPD device 100 starts to operate, an initialization is required to stimulate the inactive charged particles 101 of the pixel P1. The initialization phase is to apply a positive voltage V_{POS} followed by a negative voltage V_{NEG} for the charged particles 101 to move to an initialization position in the pixel P1. After the initialization phase is completed, the positive voltage V_{POS} is applied to the lower electrode 104 for the duration t_{G1}, for moving the charged particles 101 to a position corresponding to the grey level G1, so as to write the grey level G1 into the pixel P1. The pixel P1 needs to be erased before the next grey level G2 is written into the pixel P1. Typically, the duration for the erasing step is approximately equivalent to the duration of the previous writing step. Therefore, the negative voltage V_{NEG} is applied to the lower electrode 104 for the duration t_{G1}, for moving the charged particles 101 back to the initialization position. After the erasing step for the pixel P1 is completed, the positive voltage V_{POS} is applied to the lower electrode 104 for the duration t_{G2}, to write the grey level G2 into the pixel P1. Furthermore, after the grey-level data is written into the pixels, the charged particle 101 is able to retain the current position even without applying any driving voltage; this is the bi-stable characteristic of the EPD device. Therefore, the EPD device is able to keep the last displayed frame even after the power is turned off, and the EPD device consumes power only when the displayed frame is refreshed (i.e. applying the driving voltage for creating an electric field to move the charged particles to a different position).

However, when erasing the pixel P1, the initialization position of the charged particle 201 is constant. For example, assuming the display frame I requires time “t” to refresh from the grey level of complete black to the grey level of complete white, the time required for the display frame I to write and erase the corresponding grey-level data are twice the time “t” (i.e. the duration of the writing step equals to the duration of the erasing step). Therefore, the time it takes for the conventional EPD device to fresh a displayed frame is usually excessive. When the time of which the EPD device takes to refresh a displayed frame is excessively elongated, motion blur spawns, and the display quality is deteriorated.

### SUMMARY OF THE INVENTION

The present invention discloses a method for driving an electrophoretic display (EPD) device. The method comprises writing a first grey level to a first pixel; when the first grey level is closer to a grey level of complete black, erasing the first grey level to the grey level of complete black; when the first grey level is closer to a grey level of complete white, erasing the first grey level to the grey level of complete white; and writing a second grey level to the first pixel after the first pixel is erased.

The present invention further discloses a method for driving an EPD device. The method comprises writing a first grey level to a first pixel; erasing the first grey level to a predetermined grey level between a grey level of complete white and a grey level of complete black; and writing a second grey level to the first pixel after the first pixel is erased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional EPD device.

FIG. 2 is a diagram illustrating the movement of the charged particles when the driving voltage is applied.

FIG. 3 is a diagram illustrating the EPD device of the present invention.

FIGS. 4a and 4b are diagrams illustrating the lookup table in FIG. 3.

FIG. 5 and FIG. 6 are diagrams illustrating a first embodiment of the method for driving the EPD device of the present invention.

FIGS. 7 and 8 are diagrams illustrating the second embodiment of the method for driving the EPD device of the present invention.

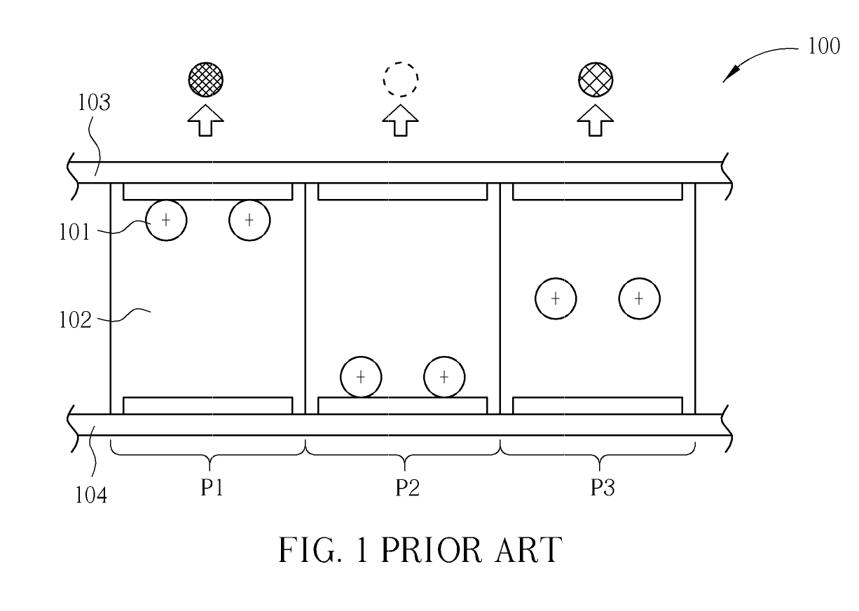

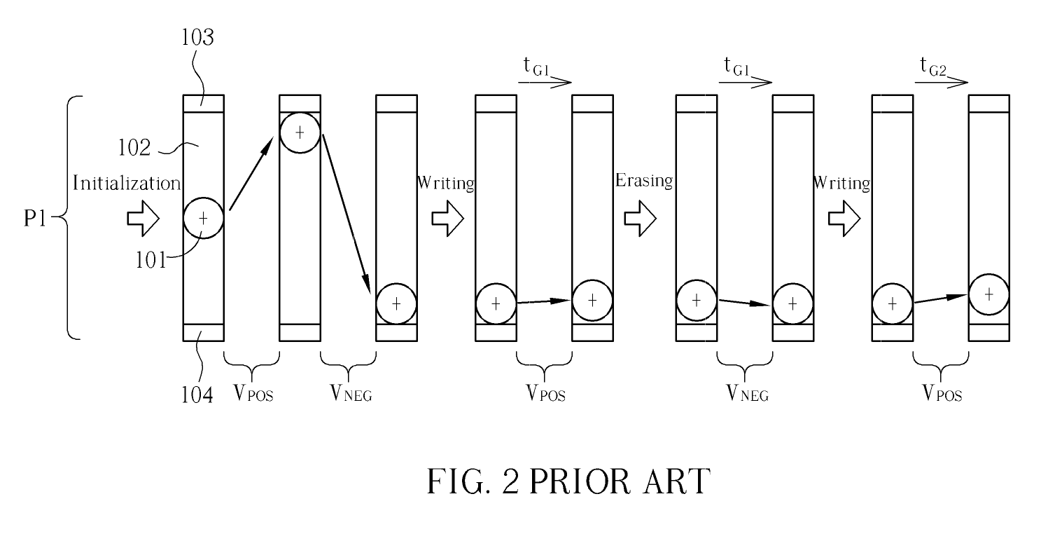

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”Also, the term “electrically connect” is intended to mean either an indirect or direct electrical connection. Accordingly, if one device is coupled to another device, that connection may be through a direct electrical connection, or through an indirect electrical connection via other devices and connections.

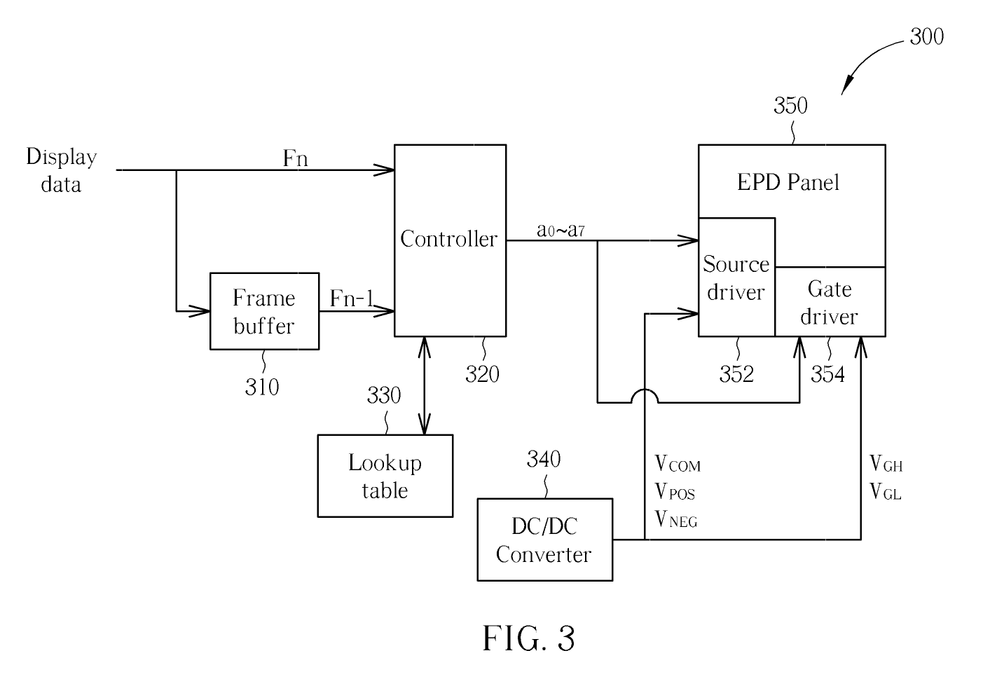

Please refer to FIG. 3. FIG. 3 is a diagram illustrating the EPD device 300 of the present invention. The EPD device 300 comprises a frame buffer 310, a controller 320, a lookup table 330, a DC/DC converter 340 and an EPD panel 350. The display frame data of the EPD device 300 can be temporarily stored in the frame buffer 310, so the controller 320 can compare the differences between the display frame data F_{N} and F_{N-1}, where the display frame data F_{N} represents the display frame data of a current display frame and the display frame data F_{N-1} represents the display frame data of a displayed frame previous to the current display frame. Each of the display frame data F_{N} and F_{N-1} comprises a plurality of grey levels. The controller 320 obtains the control data a₀˜a₇ from the lookup table 330 according to the grey level difference between the display frame data F_{N} and F_{N-1} for the same pixel. The control data a₀˜a₇ carries the data such as voltage polarity and pulse period required for one pixel of the display frame data F_{N-1} to update to the same pixel of the display frame data F_{N}. The DC/DC converter 340 is utilized for generating the driving voltages V_{COM}•V_{GH}•V_{GL}•V_{POS} and V_{NEG}. The EPD panel 350 comprises a source driver 352 and a gate driver 354. The source driver 352 and the gate driver 354 drives the charged particles in the EPD panel 350 to move according to the driving voltages V_{COM}•V_{GH}•V_{GL}•V_{POS} and V_{NEG}.

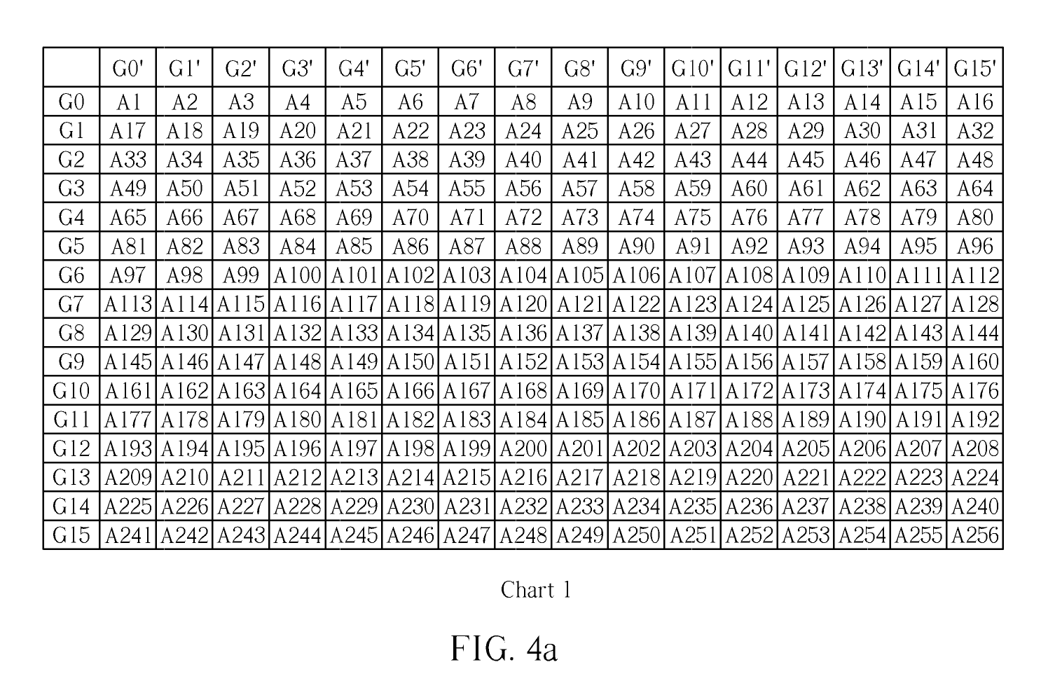

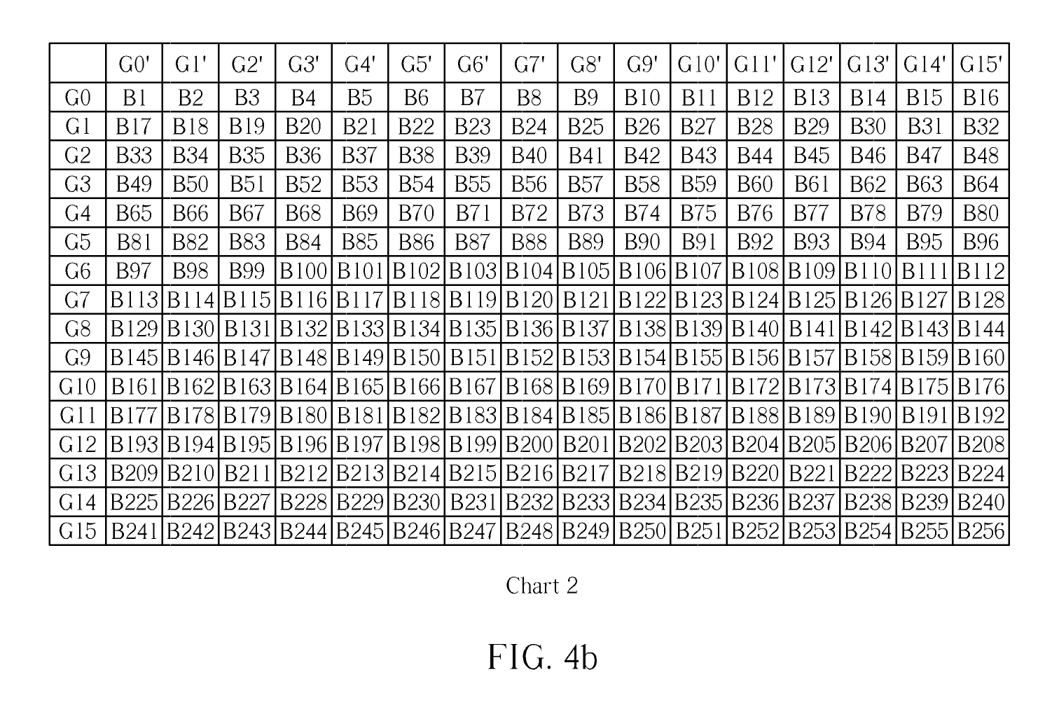

Please refer to FIG. 3, FIGS. 4a and 4b together. FIGS. 4a and 4b are diagrams illustrating the lookup table 330 in FIG. 3. As illustrated by Chart 1 of FIG. 4a, the grey levels G0′˜G15′ represents the grey levels for one pixel of a current display frame data and grey levels G0˜G15 represents the grey levels for the same pixel of the display frame data previous to the current display frame data. Chart 1 stores the transition data A1˜A256 for transforming grey levels G0˜G15 to grey levels G0′˜G15′. For instances, to transform grey level G0 to G1′, the transition data A2 is utilized. The source driver 352 determines the output voltage Vs according to the transition data A11˜A256. The transition data A1˜A256 carry the data such as voltage polarity and pulse period required for updating the grey levels G0˜G15 to the grey levels G0′˜G15′. Each of the transition data A1˜A256 comprises the control data a₀˜a₇ of 8 bits (i.e. each of the control data a₀˜a₇ is 1 bit), wherein 2 bits (e.g. control data a₀ and a₁) are utilized to determine the voltage polarity of the output voltage V_{S}. For example, when the bit value of the control data a₀ and a₁ are [00], the output voltage V_{S} is V_{POS}; when the bit value of the control data a₀ and a₁ are [01], the output voltage V_{S} is V_{SS}; when the bit value of the control data a₀ and a₁ are [10], the output voltage V_{S} is V_{NEG}. Furthermore, the other 6 bits (e.g. control data a₂˜a₇) of every transition data A1˜A256 represent the pulse period of the output voltage V_{S}. For instances, when the bit value of control data a₂˜a₇ is [000001], the pulse period of the output voltage V_{S} is 1 unit; when the bit value of control data a₂˜a₇ is [111111], the pulse period of the output voltage V_{S} is 63 units. Assuming a pixel P1 is to update from grey level G3 to grey level G9, the controller 320 obtains the corresponding transition data A58 from the lookup table 330; also, assuming the bit value of the control data a₀˜a₁ of the transition data A58 is [00], and the bit value of the control data a₂˜a₇ of the transition data A58 is [01011], then the source driver 352 outputs the voltage V_{POS} for 11 units.

Furthermore, when the driving voltage is of a swing waveform, the controller 320 also needs to obtain the transition data of the driving voltage V_{COM} from Chart 2 of FIG. 4b. Each of the transition data B1˜B256 of Chart 2 comprises the control data b₀˜b₇ of 8 bits (i.e. each of the control data b₀˜b₇ is 1 bit), wherein 2 bits (e.g. control data b₀ and b₁) are utilized to determine the voltage polarity of the output voltage V_{COM}, and the other 6 bits (e.g. control data b₂˜b₇) are utilized to determine the pulse period of the driving voltage V_{COM}. For instances, when the bit value of the control data b₀ and b₁ are [00], the driving voltage V_{COM} is V_{NEG}; when the bit value of the control data b₀ and b₁ are [01], the driving voltage V_{COM} is V_{SS}; when the bit value of the control data b₀ and b₁ are [10], the driving voltage V_{COM} is V_{POS}. The pulse period of the driving voltage V_{COM} is determined in a way similar to the above-mentioned output voltage V_{S}. However, it is noticeable that when the driving voltage V_{COM} is of a swing waveform, the voltage polarity of the driving voltage V_{COM} is opposite to the voltage polarity of the output voltage V_{S} of the source driver 352. For instances, when the output voltage V_{S} is V_{POS}, the driving voltage V_{COM} is V_{NEG}. In this way, when the driving voltage V_{COM} is of a swing waveform, the movement speed of the charged particles in the electrophoretic medium can be increased, consequently improving the time of which the EPD device takes to refresh the displayed frame.

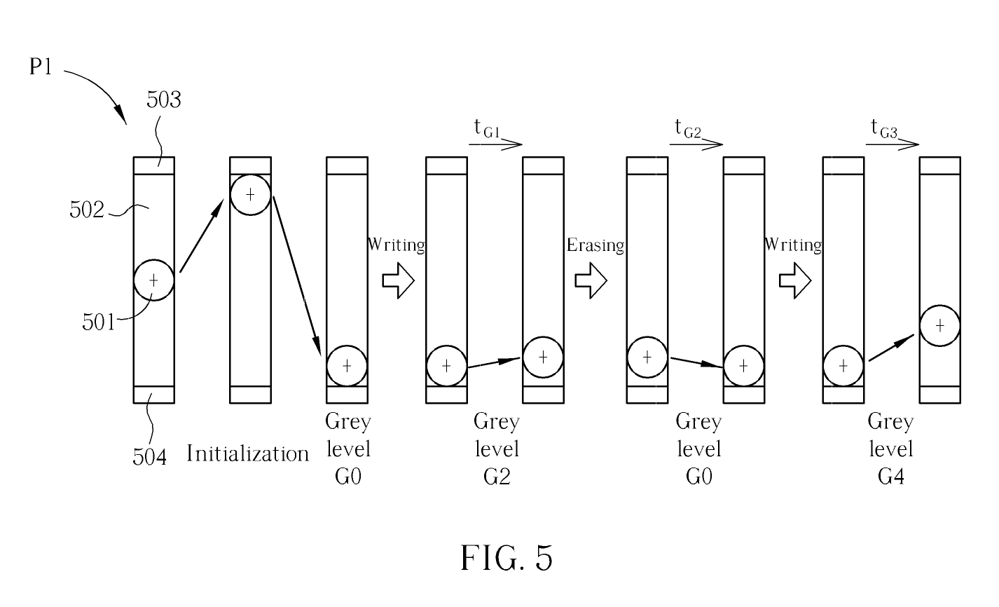

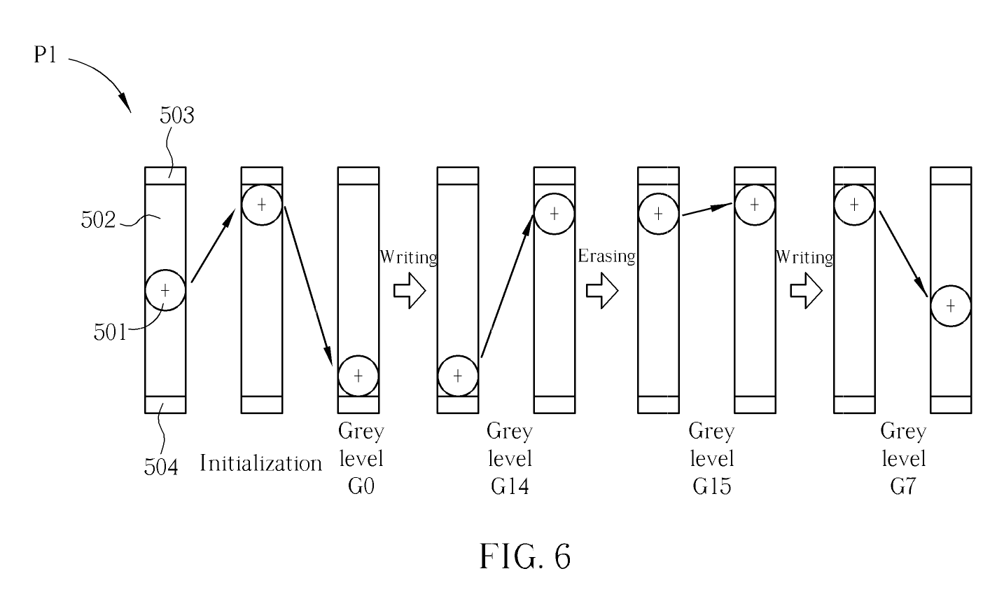

Please refer to FIG. 3, FIG. 5 and FIG. 6 together. FIG. 5 and FIG. 6 are diagrams illustrating a first embodiment of the method for driving the EPD device 300 of the present invention. In the present embodiment, the EPD device 300 utilizes the frame buffer 310 to store the display frame data Fₙ₋₁ (i.e. the display frame data of the display frame previous to the current display frame) and the EPD device 300 obtains the corresponding transition data according to the lookup table 330 and the grey level difference between the current display frame and the previous display frame. When the display frame data Fₙ₋₁ corresponds to a grey level that is closer to the grey level of black (i.e. when the display frame data Fₙ₋₁ corresponds to grey level G1˜G7), indicating the charged particle 501 of the display frame is positioned closer to the lower electrode 504, the charged particle 501 is erased back to the position of grey level G0 (i.e. the grey level of complete black). On the other hand, when the display frame data Fₙ₋₁ corresponds to a grey level that is closer to the grey level of white (i.e. when the display frame data Fₙ₋₁ corresponds to grey level G8˜G15), indicating the charged particle 501 of the display is positioned closer to the upper electrode 503, the charged particle 501 is erased back to the position of grey level G15 (i.e. the grey level of complete white). Therefore, the time required to erase the charged particle 501 is reduced, further improving the time of which the EPD device takes to refresh the displayed frame.

Please continue referring to FIG. 5, as the pixel P1 is to display the grey level G2 followed by the grey level G4. After the pixel P1 has completed initialization, the charged particle 501 is back to the position of the grey level G0. Next, the grey level G2 is to be written to the pixel P1. Therefore, the controller 320 obtains the transition data A3 according to Chart 1. According to the control data a₀˜a₇ of the transition data A3, the EPD panel 350 applies the positive voltage V_{POS} to the lower electrode 504 for the duration t_{G1}, so as to move the charged particle 501 to a position corresponding to the grey level G2 in the electrophoretic medium 502. Prior writing the next grey level G4 to the pixel P1, the pixel P1 must be erased. Because the current position of the charged particle 501 corresponds to the grey level G2, the charged particle 501 is to be erased to the position of the grey level G0. Therefore the controller 320 obtains the transition data A33 according to Chart 1. According to the control data a₀˜a₇ of the transition data A33, the EPD panel 350 applies the negative voltage V_{NEG} to the lower electrode 504 for the duration t_{G2}, so as to move the charged particle 501 to a position corresponding to the grey level G0 in the electrophoretic medium 502. Next, the grey level G4 is to be written to the pixel P1 and the controller 320 obtains the corresponding transition data A5 according to Chart 1. According to the control data a₀˜a₇ of the transition data A5, the EPD panel 350 applies the positive voltage V_{POS} to the lower electrode 504 for the duration t_{G3}, so as to move the charged particle 501 to a position corresponding to the grey level G4 in the electrophoretic medium 502 to write the grey level G4 to the pixel P1.

Please continue referring to FIG. 6, as the pixel P1 is to display the grey level G14 followed by the grey level G7. After the pixel P1 has completed initialization, the charged particle 501 is back to the position corresponding to the grey level G0. Next, the grey level G14 is to be written to the pixel P1. Therefore, the controller 320 obtains the transition data A15 according to Chart 1 for writing the grey level G14 to the pixel P1. Prior writing the next grey level G7 to the pixel P1, the pixel P1 must be erased. Because the current position of the charged particle 501 corresponds to the grey level G14, the charged particle 501 is to be erased to the position corresponding to the grey level G15. Therefore, the controller 320 obtains the transition data A240 according to Chart 1, for erasing the charged particle 501 to the position corresponding to the grey level G15 from the grey level 14. After that, the controller 320 obtains the transition A248 according to the Chart 1, for writing the grey level G7 to the pixel P1.

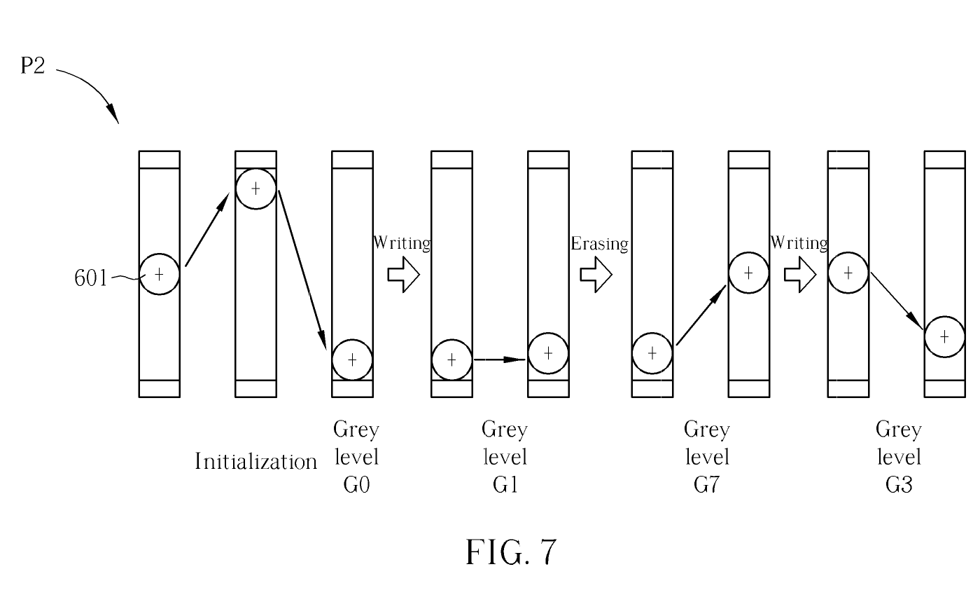

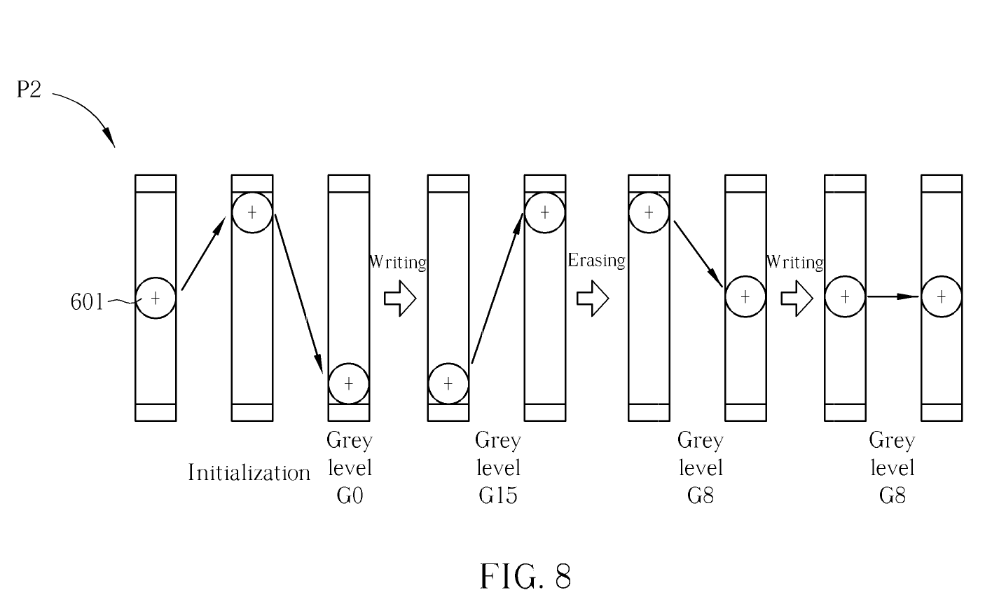

Please refer to FIG. 7 and FIG. 8 together. FIGS. 7 and 8 are diagrams illustrating the second embodiment of the method for driving the EPD device 300 of the present invention. In the present embodiment, the charged particle 601 is erased back to a position corresponding to the middle grey level, regardless of if the display frame data Fₙ₋₁ corresponds to a grey level that is closer to the grey level of complete black (i.e. when the display frame data Fₙ₋₁ corresponds to the grey levels G1 G7), or a grey level that is closer to the grey level of complete white (i.e. when the display frame data Fₙ₋₁ corresponds to the grey levels G8˜G15). The middle grey level, for instances, may be the grey level G7 or the grey level G8. In other words, when writing a grey level to the pixel after the erasing step, the charged particle 601 moves to a position corresponding to other grey levels from the grey levels G7 or G8. Therefore, the time required to write/erase the pixel is reduced, further improving the time of which the EPD device takes to refresh the displayed frame.

Please continue referring to FIG. 7, as the pixel P2 is to display the grey level G1 followed by the grey level G3. After the pixel P2 has completed initialization, the charged particle 601 is back to the position corresponding to the grey level G0. Next, the grey level G1 is to be written to the pixel P2. Therefore, the controller 320 obtains the transition data A2 according to Chart 1 for writing the grey level G1 to the pixel P2. Prior writing the next grey level G3 to the pixel P2, the pixel P2 must be erased. Therefore, the controller 320 obtains the transition data A24 according to Chart 1, for erasing the charged particle 601 back to the position corresponding to the grey level G7 from the grey level 1 (i.e. erasing the charged particle 601 to the position corresponding to the middle grey level). After that, the controller 320 obtains the transition A116 according to the Chart 1, for writing the grey level G3 to the pixel P2.

Please continue referring to FIG. 8, as the pixel P2 is to display the grey level G15 followed by the grey level G8. After the pixel P2 has completed initialization, the charged particle 601 is back to the position corresponding to the grey level G0. Next, the grey level G15 is to be written to the pixel P2. Therefore, the controller 320 obtains the transition data A16 according to Chart 1 for writing the grey level G15 to the pixel P2. Prior writing the next grey level G8 to the pixel P2, the pixel P2 must be erased. Therefore the controller 320 obtains the transition data A249 according to Chart 1, for erasing the charged particle 601 back to the position corresponding to the grey level G8 from the grey level 15 (i.e. erasing the charged particle 601 to the position corresponding to the middle grey level). After that, the controller 320 obtains the transition A137 according to the Chart 1, for writing the grey level G8 to the pixel P2.

In conclusion, the present invention provides a method for driving the EPD device, for improving the time of which the EPD device takes to refresh the displayed frame. The EPD device comprises a frame buffer, a lookup table, a controller and an EPD panel. The frame buffer stores a first display data. The controller obtains a transition data of transforming the first display frame data to a second display frame data from the lookup table, and outputs a control data. The EPD panel displays the second display data according to the control data. Therefore, by utilizing the lookup table, the method for driving the EPD device of the present invention can adjust the position the charged particles in the pixel to be moved to during the erasing step, for reducing the time required to erase the pixel and consequently improving the display quality of the EPD device.

Those skilled in the art will readily observe that numerous modifications and alterations of the device and method may be made while retaining the teachings of the invention.

What is claimed is:

1. A method for driving an electrophoretic display (EPD) device, the method comprising:
writing a first grey level to a first pixel;
when the first grey level is closer to a grey level of complete black, erasing the first grey level to the grey level of complete black;
when the first grey level is closer to a grey level of complete white, erasing the first grey level to the grey level of complete white; and
writing a second grey level to the first pixel after the first pixel is erased.

2. The method of claim 1, further comprising:
providing a lookup table of transition data for transforming grey levels.

3. The method of claim 2, wherein when the first grey level is closer to the grey level of complete white, erasing the first grey level to the grey level of complete white comprises:
obtaining a transition data of transforming the first grey level to the grey level of complete white according to the lookup table; and
erasing the first pixel according to the transition data of transforming the first grey level to the grey level of complete white.

4. The method of claim 2, wherein when the first grey level is closer to the grey level of complete black, erasing the first grey level to the grey level of complete black comprises:
obtaining a transition data of transforming the first grey level to the grey level of complete black according to the lookup table; and
erasing the first pixel according to the transition data of transforming the first grey level to the grey level of complete black.

5. The method of claim 4, wherein writing the first grey level to the first pixel comprises applying a positive voltage to the first pixel for a first duration, and writing the second grey level to the second pixel comprises applying the positive voltage to the second pixel for a second duration.

6. The method of claim 5, wherein erasing the first grey level to the grey level of complete black comprises applying a negative voltage to the first pixel for the first duration, and erasing the first grey level to the grey level of complete white comprises applying the positive voltage to the first pixel for a third duration.

7. The method of claim 6, wherein the positive voltage, the negative voltage, the first duration, the second duration and the third duration are stored in the lookup table.

8. A method for driving an EPD device, the method comprising:
writing a first grey level to a first pixel;
erasing the first grey level to a predetermined grey level between a grey level of complete white and a grey level of complete black; and
writing a second grey level to the first pixel after the first pixel is erased.

9. The method of claim 8, wherein the predetermined grey level is a middle grey level between the grey level of complete white and the grey level of complete black.

10. The method of claim 9, further comprising:
providing a lookup table of transition data of transforming grey levels.

11. The method of claim 10, wherein erasing the first grey level to the predetermined grey level between the grey level of complete white and the grey level of complete black comprises:
obtaining a transition data of transforming the first grey level to the predetermined grey level according to the lookup table; and
erasing the first pixel according to the transition data of transforming the first grey level to the predetermined grey level.

12. An EPD device, the EPD device comprising:
a frame buffer, for storing a first display frame data;
a lookup table;
a controller, electrically connected to the frame buffer and the lookup table, for obtaining a transition data of transforming a first grey level of the first display frame data corresponding to a first pixel to a second grey level of a second display frame data corresponding to the first pixel from the lookup table, and outputting a control data accordingly; and
an EPD panel, electrically connected to the controller, for displaying the second grey level of the second display frame data according to the control data.

13. The EPD device of claim 12, further comprising:
a DC/DC converter, electrically connected to the EPD panel, for providing driving voltages to the EPD panel.

14. The EPD device of claim 13, wherein the lookup table is utilized to store the transition data for the first grey level corresponding to the first pixel to transform to the second grey level corresponding to the first pixel.
